(19) United States
(12) Patent Application Publication
(10) Pub. No.: US 2012/0053728 A1
(43) Pub. Date: Mar. 1, 2012

(54) OBJECT-LEARNING ROBOT AND METHOD

(75) Inventors: Boudewijn Theodorus Theodorus, Eindhoven (NL); Harry Broers, Eindhoven (NL)

(73) Assignee: KONINKLIJKE PHILIPS ELECTRONICS N.V., EINDHOVEN (NL)

(21) Appl. No.: 13/265,894

(22) PCT Filed: Apr. 13, 2010
(86) PCT No.: PCT/IB10/51583

§ 371 Date: Oct. 24, 2011

(30) Foreign Application Priority Data
Apr. 23, 2009 (EP) 09158605.7

(51) Int. Cl. G05B 15/00

(52) U.S. Cl. 700/259; 901/47

(57) ABSTRACT

The present invention relates to an object-learning robot and corresponding method. The robot comprises a gripper (14) for holding an object (11) to be learned to the robot (10); an optical system (16) having a field of view for introducing the object (11) to the robot (10) and for observing the gripper (14) and the object (11) held by the gripper (14); an input device (26) for providing an object identity of the object to be learned to the robot (10); a controller (24) for controlling the motion of the gripper (14) according to a predetermined movement pattern; and an image processing means (28) for analyzing image data obtained from the optical system (16) identifying the object (11) for association with the object identity. This enables the robot to learn the identity of new objects in a dynamic environment, even without an offline period for learning.

### FIELD OF THE INVENTION

The present invention relates to an object-learning robot and a corresponding method.

### BACKGROUND OF THE INVENTION

Object recognition is a widely studied subject in vision research. A method to do this consists of presenting multiple images of an object so that the algorithm learns the distinguishing features. This is usually done “off-line”, i.e. the presenting of the images is done before, and there is no adaptation or “learning” during use.

Kitchen aid robot arms can pick and place objects from/to shelves, cupboards, fridge, oven, worktop, dishwasher, etc. Furthermore such a robot arm can clean the worktop, cut vegetables, rinse dishes, prepare fresh drinks, etc. However, present robots have a number of limitations that affect their usefulness.

Present robot object-learning systems consist of presenting multiple images of an object to the robot so that the algorithm operating the robot learns the distinguishing features of the objects in the images. This process is typically accomplished when the robot is offline, i.e. when the robot is not in service or is not being used for other tasks.

JP 2005-148851 A discloses a robot device and method for learning an object which discloses both an object-learning phase and an object-recognition phase of operation. Further, the document discloses that the robot requires dialog with a user and that a voice output means is provided for this dialog.

### SUMMARY OF THE INVENTION

An object of the invention is to provide an object-learning robot and a corresponding method that learns the identity of new objects in a dynamic environment, without an offline period for learning.

Another object of the invention is to provide an object-learning robot and method that permits a robot to learn an object as the object is shown to the robot.

In a first aspect of the present invention, an object-learning robot is proposed, including

a gripper for holding an object to be learned to the robot;

an optical system having a field of view for introducing the object to the robot and for observing the gripper and the object held by the gripper;

an input device for providing an object identity of the object to be learned to the robot;

a controller for controlling the motion of the gripper according to a predetermined movement pattern; and

an image processing means for analyzing image data obtained from the optical system identifying the object for association with the object identity.

In another aspect of the present invention, a method for an object-learning robot is proposed, including the steps of:

introducing an object to be learned in a field of view of an optical system for the robot to indicate to the robot that the object is to be learned;

providing an object identity corresponding to the object to be learned to the robot (10) with an input device of the robot;

holding the object to be learned in a gripper of the robot;

controlling the motion of the gripper and the object to be learned according to a predetermined movement pattern; and

analyzing image data obtained from the optical system for identifying the object for association with the object identity.

The inventive device and method provide the advantage that a robot may be taught the identity of new objects as they are encountered, without waiting for or initiating off-line educational periods. In addition, it is advantageous to have an object-learning robot and corresponding method for teaching new objects to an object-learning robot that permits a robot to be taught new objects while the robot is in service and does not interrupt the normal workflow. Further, the invention provides the advantage of teaching new objects to an object-learning robot that does not require that the robot verbally initiate the learning process, but is initiated by the robot's operator through the presentation of the object to be learned in a regular or oscillatory manner in the robot's field of view. Hence, for instance, a simple, non-verbal signal that signals the robot to start the learning process on-the-fly, can be sufficient for initiating the learning phase. This can be done at any time and does not need to be scheduled.

Further, it is advantageous that the object-learning robot and method include a controller that directs a pattern of predetermined movements of the gripper and the object to be learned, so as to quickly determine the visual characteristics of the object to be learned.

In order to perform online learning by presenting objects to an object-learning robot, it is necessary that the robot ‘can be told’ which objects are examples of the object to be recognized. Thus, it is a further advantage to have an object-learning robot and corresponding method that permits on-the-fly identification of the objects to be learned so that the robot will know the name or identity of the object of interest, on which it is focusing its attention.

The disclosed robot and method can be used on-line or off-line, but offers innovative features unknown in the prior art. The robot and method do not simply compare two static images, but a series of images, such as a live view from an optical system. This arrangement provides several advantages: object segmentation for a series of images, so that objects of interest are viewed from several view angles to achieve a more complete, comprehensive view of their characteristics; greater reliability, with less sensitivity to, and no dependence on, varying lighting conditions during object teaching; a faster method that requires no before/after comparison, because information from all images can be used; no voice commands from robot to the user—the user must only hand the object to the robot; and therefore the method is also more intuitive.

According to an embodiment, the gripper is mounted on an arm of the robot. This provides the advantage that the range of motion of the arm and gripper may be made similar to that of a human. This simplifies the accommodations that need to be made in having and operating a robot.

According to another embodiment, the optical system is mounted to the arm of the robot. This provides the advantage that the motion of the arm and the motion of the camera will be similar or even uniform, depending on the exact placement of the camera on the arm. This simplifies the algorithm with respect to identifying the gripper, the object to be learned that is in the gripper, as well as the background information, which is not important during the robot's learning. More particularly, when the image sequence, e.g. the image data obtained from the optical system for identifying the object for association with the object identity, is integrated over time, the background may become blurred or less distinct while the object of interest, and perhaps the robot arm itself, may not become blurred. Alternatively, any blurring may be small, due to compliance or other mechanical imperfections of the arm including a gripper.

According to a further embodiment, the optical system comprises two or more cameras, which are preferably mounted on the robot arm. This provides the advantage of a stereo image which provides detailed three-dimensional information to the algorithm regarding numerous aspects and details of the object to be learned.

According to an additional embodiment, the image processing means is adapted for recognizing a regular or oscillatory motion of the object in the field of view by which the object is introduced to the robot optical system. In this way the robot can be told to start the learning phase.

According to another embodiment the optical system provides an overall image, including stationary pixels, moving pixels, known pixels and unknown pixels. Advantageously, the information is provided to the robot regarding the position of the gripper and its orientation, as well as the object to be learned in the gripper and the background image. Thus each part of the image may be identified and resolved separately. This provides the advantage that image segmentation can be performed quickly and effectively. That is, a region/object of interest is readily identified as well as the pixels which belong to the region/object of interest. The segmentation problem is solved in an intuitive, elegant and robust way, and as a bonus, additional information can be learned about the object according to the grasping method, compliance of the object, etc. . . .

According to another embodiment, the image processing means is adapted to direct the movement of the gripper and object to be learned by the robot according to a predetermined movement pattern. The predetermined movement pattern includes a known movement and manipulation pattern, e.g. translation and rotation, and provides means to distinguish the object to be learned, the gripper and the background image information from each other.

According to another embodiment, the image processing means is adapted to monitor a position and movement of the gripper. Hence, the position and movement of the gripper (having a known form/image) as it is seen in the overall image can be determined.

According to a further embodiment, the image processing means is adapted to determine the shape, color and/or texture of the object to be learned. The controller directs the movement of the gripper and the object to be learned held by the gripper. Thus, the image processing means is able to determine various parameters and characteristics of the object to be learned in the gripper because it is able to know which parts of the overall image are the gripper and is thereby able to eliminate those parts accordingly, so as to sense and measure the object to be learned.

According to another embodiment, the overall image from the optical system includes pixels belonging to the gripper. The controller directs the movement of the gripper and knows, according to this directed movement, the position and orientation of the gripper. Thereby, it is known which pixels in the overall image are associated with the gripper. The gripper, which is not an object to be learned, is thus easily identified and ignored or removed from the overall image so that a lesser amount of irrelevant information remains in the overall image.

According to a further embodiment, the image processing means is adapted to subtract the pixels belonging to the gripper from the overall image to create a remaining image. This provides the advantage of a smaller number of pixels to be processed and identified in subsequent analysis. In this manner, the visual features of the gripper are not associated with the object of interest.

According to another embodiment, the image processing means is adapted to detect the remaining image, which includes object pixels and background pixels. Having only two sets of pixels remaining in the images significantly reduces the amount of processing needed to identify the object to be learned.

According to a subsequent embodiment, the image processing means is adapted to detect the background pixels. As the controller directs the movement of the gripper and the object to be learned in the gripper, the image processing means removes the gripper from the overall image so that only the remaining image includes only the object to be learned and the background. The object to be learned exhibits a movement pattern associated with the predetermined movement pattern directed by the controller. The background is stationary or does not exhibit motion according to the controller or that is correlated with the predetermined motion of the arm. Thus, the background pixels are easily identified and removed from the remaining image, which leaves only the object to be learned.

According to a further embodiment, the image processing means is adapted to detect the object pixels according to the predetermined movement pattern. As the controller directs the movement of the gripper and the object to be learned in the gripper, the image processing means is able to remove the gripper from the overall image so that only the remaining image includes only the object to be learned and the background. The object to be learned exhibits a movement pattern associated with the predetermined movement pattern. The background is stationary or does not exhibit motion according to the predetermined movement pattern. Thus, the pixels that exhibit motion according to the predetermined movement pattern are identified as belonging to the object in the gripper and, therefore, the object to be learned.

According to another embodiment, the image processing means is adapted to identify the object to be learned according to the object pixels. The identification of the object is accomplished by the identification of the object pixels, which move according to the predetermined movement pattern when the object is held by the gripper. Thus learned, the object is ready to be incorporated into the robot's database, wherein the robot is ready to provided assistance with respect to the object.

According to a further embodiment, the robot includes a teaching interface adapted to monitor and store a plurality of movements of the robot arm. Thus, the user can control the robot to pick up an object, e.g. by using a remote/haptic interface, or the user can grab the robot by the arm and directly guide it to teach the robot how to pick up or grasp a particular object of interest. The grasping method may be incorporated and stored and associated with the identification of the object in order to streamline subsequent encounters with the object. This encourages the semi-autonomous execution of the tasks by the robot, and makes it more helpful.

### BRIEF DESCRIPTION OF THE DRAWINGS

These and other aspects of the invention will be apparent from and elucidated with reference to the embodiments described hereinafter. In the following drawings

FIG. 1 illustrates an object-learning robot in accordance with an embodiment of the invention,

FIG. 2 illustrates a method for object learning for a robot in accordance with an embodiment of the invention,

FIG. 3 illustrates more details of an object-learning method in accordance with an embodiment of the invention, and

FIG. 4 illustrates a diagram showing a possible view of overall pixels, background pixels and coherent pixels including gripper pixels and object pixels.

### DETAILED DESCRIPTION OF THE INVENTION

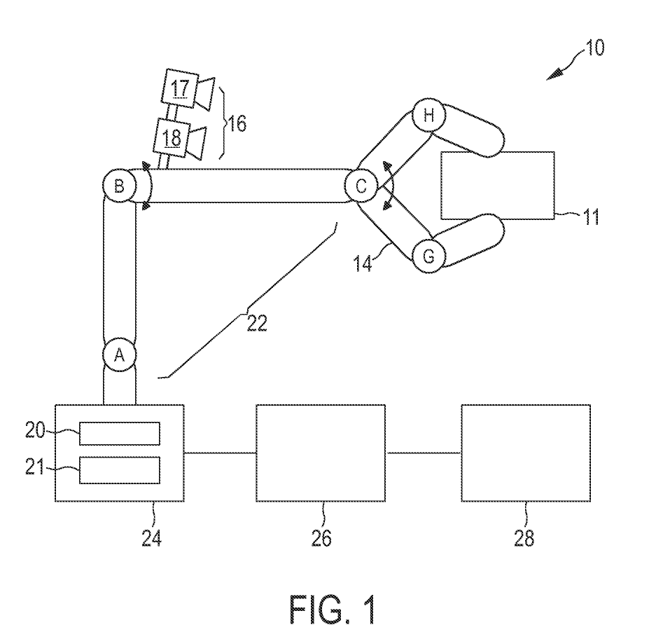

FIG. 1 illustrates an arrangement of an object-learning robot 10. The robot 10 includes a gripper 14, an optical system 16, an input device 26, a controller 24 and an image processing means 28. The gripper 14 permits the robot 10 to accept, hold and manipulate an object 11 to be learned. The optical system 16 includes a field of view for observing the gripper 14 and any object 11 to be learned. The input device 26 is in communication with the controller 24 and allows a user to identify the object 11 to be learned to the robot 10. The input device 26 for providing an object's identity may be an audio device, e.g. a microphone, or may be a keyboard, touchpad or other device for identifying the object to the robot 10. The user can control the robot 10 to pick up an object with the input device 26, e.g. a remote/haptic interface. Alternatively, the end-user can take the robot 10 by the arm or gripper 14 and directly guide it, or may direct it via a teaching interface 21 connected to the arm 22/gripper 14. The user may therein teach the robot 10 a particular manner of grasping or handling a particular object of interest. This gives the additional advantage that the robot 10 can associate a grasping method with the object of interest.

The controller 24 is in communication with the gripper 14, the optical system 16, the input device 26 and the image processing means 28. The controller 24 is used to direct the gripper 14 in the field of view of the optical system 16 according to a predetermined movement pattern, e.g. translation and rotation. The image processing means 28 then analyzes the image data acquired by and received from the optical system 16 in order to learn the object and associate it with the object's identity.

The controller 24 may include an algorithm 20 for directing the predetermined motion of the gripper 14 and the object held in the gripper 14. However, other hardware and software arrangements may be used for implementing the controller 24. Similarly, the image processing means 28 may be implemented in software, e.g. on a microprocessor, or hardware, or a mixture of both.

The robot 10 may have a particular task, i.e. kitchen assistant or household cleaning, and may have various appendages or abilities based on this purpose. The gripper 14 may be mounted to a robot arm 22. This arrangement provides for a wide range of motion and influence for the robot 10 in accomplishing its designated tasks. The arrangement is also similar to the arm and hand arrangement of humans, and so may be easier for a user to relate to or accommodate. Additional applications for the robot may include, but are not limited to, ergonomy, distance, safety, assistance to elderly and disabled, and tele-operated robotics.

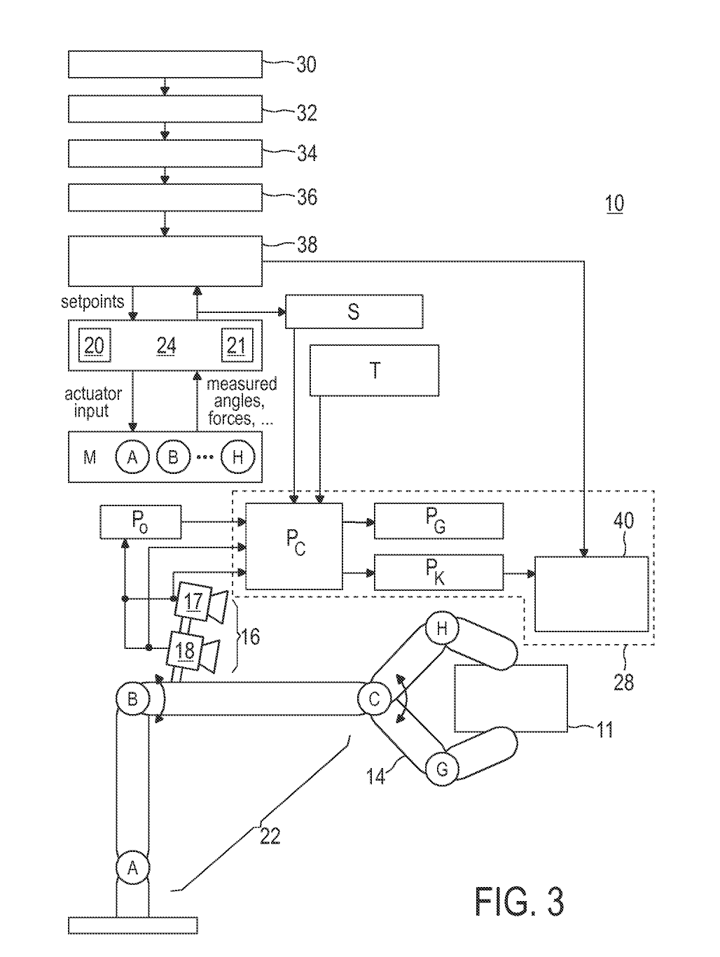

The optical system 16 may be mounted on the arm 22, and may further include one or more cameras 17, 18, which may be mounted on the arm 22 or elsewhere on the robot 10. A single camera 17 may provide useful information regarding the position of the gripper 14 as well as the position of the object to be learned, wherein the controller 24 and the image processing means 28 are employed to observe, analyze and learn the object 11 to be learned. Where two or more cameras 17, 18 are employed simultaneously, as illustrated in FIGS. 1 and 3, the stereo- or three-dimensional images provided of the gripper 14 and the object 11 to be learned to the controller 24 may be more highly-detailed and informative regarding the object 11 to be learned. Further, having the optical system 16 mounted to the arm 22 provides the advantage that there are fewer possible motion variances between the optical system 16 and the object 11 to be learned what the controller 24 and the image processing means 28 would need to calculate and adjust for. This arrangement is advantageous for its simplicity as compared with head-mounted optical systems, and makes the observation of the gripper 14 and the object 11 to be learned more rapid due to the more simple requirements of the controller 24 and the image processing means 28. The cameras 17, 18 of the optical system 16 may be movable, manually or as directed by the controller 24 to accommodate a variety of arm positions and object sizes.

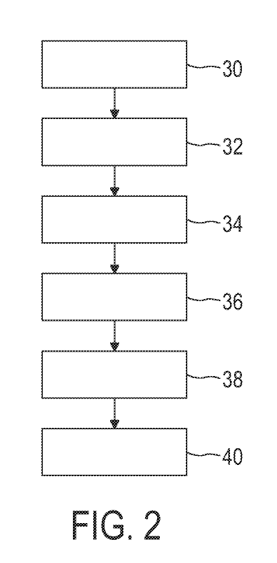

FIG. 2 illustrates a method for an object-learning robot. FIG. 3 illustrates the integration of an object-learning robot 10 with the corresponding method, which includes the steps of introducing an object 11 to be learned in a field of view of an optical system 16 for the robot 10 to indicate to the robot 10 that the object 11 is to be learned, in step 30. The object 11 can be introduced to the robot 10 with regular or oscillatory motion. Next, step 32, an object identity corresponding to the object 11 is provided to the robot 10 with an input device 26 of the robot 10. This step may be accomplished by verbally stating the name of the object to the robot 10 or by entering a code or name for the object via a keyboard or other input device on or in communication with the robot 10. The method for object learning further includes, step 34, accepting and holding the object in a gripper 14 of the robot 10. At this time the robot 10 takes over the learning process, for instance having been signaled to start the learning process by moving the object in a regular or oscillatory manner in the robot's field of view in step 30, and identifying the object to the robot 10 in step 32. Of course, the start of the learning phase can also be signaled in other ways, e.g. by giving a corresponding command via the input device 26.

Next, step 36, the robot 10 controls the motion of the gripper 14 and the object 11 according to a predetermined movement pattern according to the controller 24, which is in communication with the gripper 14. The controller 24 directs the planned or predetermined movement pattern of the gripper 14 and the object 11 in order to efficiently view as much of the object as is possible. This makes a detailed analysis of the object 11 possible. Next, step 38, the optical system 16 of the robot 10 observes the object to create an overall image Pₒ. The optical system 16 views the gripper 14 and any object 11 held by the gripper 14. Finally, step 40, the image processing means 28 analyzes the overall image Pₒ of the object 11 for association with the object identity previously provided.

The controller 24 directs the motion of the gripper 14. Thus, any object 11 in the gripper 14 moves according to the predetermined movement pattern directed by the controller 24. By this predetermined movement pattern of the controller 24, the robot 10 will observe and ultimately learn the object 11 from the images produced though the imaging system. This process may be accomplished at any time, and does not require that the robot 10 is offline, off duty or otherwise out of service. The robot 10 may resume normal activities at the completion of the predetermined observation and study movements for learning the object.

The object-learning robot 10 detects an overall image Pₒ from the predetermined movement of the object in the field of view of the optical system 16. The overall image Pₒ may include a plurality of pixels, e.g. a plurality of stationary pixels, a plurality of moving pixels, a plurality of known pixels and a plurality of unknown pixels. The various parts of the overall image Pₒ from the optical system 16 may be identified and sorted into the various categories to make the learning and subsequent identification of the object more efficient and streamlined.

The motion of the object 11 to be learned according to the controller 24 is according to a predetermined movement pattern, e.g. translation and rotation, included in the controller 24. Thus, the controller 24 directs a precise, predetermined sequence of movements of the object 11 to be learned in the gripper 14 so as to learn the object in a methodical fashion. The movements, though predetermined, may be somewhat variable in order to accommodate the wide variety of possible orientations of the object within the gripper 14, as well as to accommodate objects 11 having irregular shapes and a variety of sizes.

The state information S, e.g. the position and movement of the gripper 14, are known to the controller 24 because the controller 24 directs the position and movement. The controller 24 is in communication with the hardware associated with the gripper 14 and the arm 22. The arm 22 hardware may include a number of actuators A, B, C, which are joints to permit articulation and movement of the arm 22. The gripper 14 as well may include a number of actuators G, H to permit the gripper 14 to grasp an object 11. The actuators A, B, C, G, H may supply input or feedback information M to the controller 24 including measured angles of individual actuators and forces exerted by individual actuators in particular directions. The controller 24 directs the predetermined movements of the gripper 14 in the learning process and is in communication with the image processing means 28. Thus, the controller 24 and the image processing means 28 know the position of the gripper 14, and the pixels belonging to the gripper P_{G} are more easily identified in the image data acquired by the optical system 16.

The robot 10 may determine the shape, color and/or texture of the object according to the input information M to the controller 24. When a known force is applied to the object in a known direction, the relative hardness or softness of the object may be determined through a comparison of actual actuator angles and ideal actuator angles based upon a map of the same inputs/forces applied to an empty gripper 14 or a gripper 14 holding an object 11 having a known, or reference, hardness. Further, different types of tactile sensors may be used to provide more details regarding the tactile features T associated with the object 11.

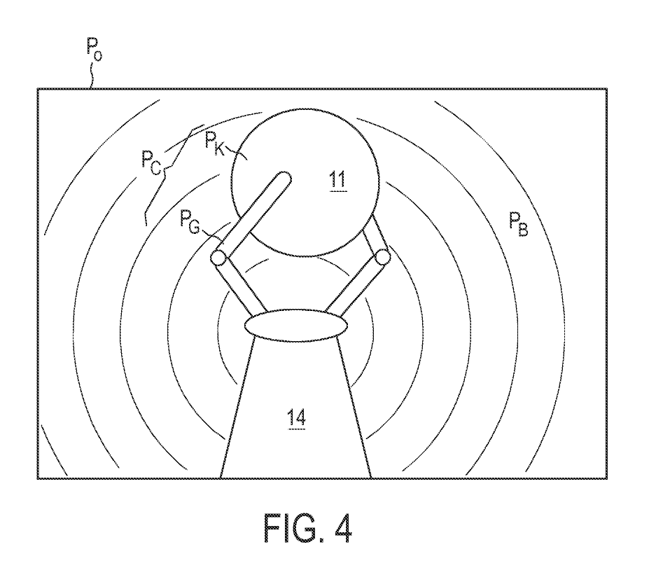

The robot 10 knows the position of the gripper 14 due to the directions from the controller 24 toward the gripper 14. The overall image may include coherent pixels P_{C} that exhibit coherent motion. That is, the motion of the coherent pixels P_{C} is coherent with respect the predetermined movement pattern directed by the controller 24. Of the coherent pixels P_{C}, some of the pixels may belong to the gripper, e.g. gripper pixels P_{G}, and the remaining pixels may be object pixels P_{K}. The pixilated appearance of the gripper 14 may be mapped and included in the controller 24 in order to quickly and easily identify the gripper pixels P_{G}. Thus, the object 11 to be learned is easily identifiable via the optical system 16 due to its position in the gripper 14. The object pixels P_{K} with the object are easily identified after the gripper pixels P_{G} are eliminated from the overall image. A possible view of overall pixels P_{O}, background pixels P_{B} and coherent pixels P_{C} including gripper pixels P_{G} and object pixels P_{K} is illustrated in FIG. 4. The background pixels P_{B} may exhibit a blur due to motion of the gripper 14, and the relative motion of the optical system 16 with respect to the gripper 14, object 11 and background.

The gripper 14 may be mounted on an arm 22 of the robot 10. This provides the advantage that the arm 22 may be adjusted or moved to grasp different objects in the gripper 14 almost anywhere within the range of the arm 22. The optical system 16 may further comprise one or more cameras 17, 18 mounted on the arm 22 of the robot 10. In this arrangement there are few joints, actuators or appendages between the optical system 16 and the gripper 14 and object 11 to be learned. The limited numbers of angular possibilities between the optical system 16 and the gripper 14 results in a more simple computational arrangement for identifying the object 11 to be learned and determining further characteristics of the object 11. Thus, the function and implementation of the controller 24 and the image processing means 28 is simplified. The optical system 16 may include two or more cameras 17, 18 which would provide stereo- or three-dimensional images of the object 11 to be learned, for more detailed learning of the object 11.

As described above, the gripper pixels P_{G} may be subtracted from the overall image Pₒ. After the gripper pixels P_{G} are subtracted from the overall image Pₒ, a significantly fewer number of pixels will remain in the overall image Pₒ. Those pixels remaining will include the background pixels and the object pixels. Thus image processing is further simplified.

According to another arrangement, after the gripper pixels P_{G} are subtracted from the overall image Pₒ, the robot 10 may detect the remaining image, which includes primarily object pixels P_{K} and background pixels. The object pixels P_{K} will exhibit coherent motion according to the predetermined motion imparted to the gripper 14 via the controller 24. The motion of the object pixels P_{K} will be consistent with the motion of the gripper 14. By contrast, the background pixels P_{B} will be generally stationary or will move in an incoherent fashion with respect to the predetermined movements directed by the controller 24. Thus, the object pixels P_{K} and background pixels P_{B} are independently identifiable. This is based on the movement differential between the predetermined motion of the object 11 to be learned, in accordance with the predetermined motion imparted from the gripper 14, and the relatively stationary or incoherent motion of the background pixels P_{B} with respect to the predetermined motion of the gripper 14 directed by the controller 24.

Accordingly, the object 11 to be learned is identified 40 by the image processing means 28. The incoherent motion of the background pixels P_{B} with respect to the predetermined motion directed by the controller 24 results in the ability of the image processing means 28 to identify the background pixels P_{B} and thereby eliminate them from the remaining image. After this step, the only object pixels P_{K} remain. The robot 10 will then associate the object 11 to be learned with the characteristics corresponding to those final remaining pixels, the object pixels P_{K}.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program, by which the control method and or the image processing method employed according to the present invention are implemented, may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. An object-learning robot (10) comprising
a gripper (14) for holding an object (11) to be learned to the robot (10);
an optical system (16) having a field of view for introducing the object (11) to the robot (10) and for observing the gripper (14) and the object (11) held by the gripper (14);
an input device (26) for providing an object identity of the object (11) to be learned to the robot (10);
a controller (24) for controlling the motion of the gripper (14) according to a predetermined movement pattern; and
an image processing means (28) for analyzing image data obtained from the optical system (16) identifying the object (11) for association with the object identity.

2. The robot according to claim 1, wherein the image processing means (28) is adapted for recognizing a regular or oscillatory motion of the object in the field of view by which the object (11) is introduced to the robot (10).

3. The robot according to claim 1, wherein the optical system (16) is mounted to a robot arm (22).

4. The robot according to claim 1, wherein the optical system (16) comprises two or more cameras (17, 18).

5. The robot according to claim 1, wherein the optical system (16) provides an overall image including stationary pixels, moving pixels, known pixels and unknown pixels.

6. The robot according to claim 1, wherein the controller (24) is adapted for directing the movement of the gripper (14) and object (11) to be learned by the robot (10) according to a predetermined movement pattern.

7. The robot according to claim 1, wherein the image processing means (28) is adapted to monitor a position and movement of the gripper (14).

8. The robot according to claim 1, wherein the image processing means (28) is adapted to determine the shape, color and/or texture of the object to be learned.

9. The robot according to claim 5, wherein the overall image from the optical system (16) includes pixels belonging to the gripper (14) and wherein the image processing means (28) is adapted to subtract the pixels belonging to the gripper (14) from the overall image to create a remaining image.

10. The robot according to claim 9, wherein the image processing means (28) is adapted to analyze the remaining image, which includes object pixels and background pixels.

11. The robot according to claim 10, wherein the image processing means (28) is adapted to detect the background pixels.

12. The robot according to claim 10, wherein the image processing means (28) is adapted to detect the object pixels according to the predetermined movement pattern.

13. The robot according to claim 12, wherein the image processing means (28) is adapted to identify the object to be learned according to the object pixels.

14. The robot according to claim 1, further comprising a teaching interface adapted to monitor and store a plurality of movements of the robot arm (22).

15. A method for an object-learning robot (10) comprising the steps of:
introducing an object (11) to be learned in a field of view of an optical system (16) for the robot (10) to indicate to the robot (10) that the object is to be learned;
providing an object identity corresponding to the object to be learned to the robot (10) with an input device (26) of the robot (10);
holding the object to be learned in a gripper (14) of the robot (10);
controlling the motion of the gripper (14) and the object to be learned according to a predetermined movement pattern; and
analyzing image data obtained from the optical system (16) for identifying the object (11) for association with the object identity.
